(19) United States
(12) Patent Application Publication
(10) Pub. No.: US 2025/0201142 A1
(43) Pub. Date: Jun. 19, 2025

(54) SYSTEMS AND METHODS FOR GENERATING A USER ATTRIBUTE SCORE

(71) Applicant: BREAKOUT LEARNING Inc., Dallas, TX (US)

(72) Inventors: Ramit Varma, Encino, CA (US); Steven Walters, Dallas, TX (US); Joshua Oster-Morris, Atlanta, GA (US)

(73) Assignee: BREAKOUT LEARNING Inc., Dallas, TX (US)

(21) Appl. No.: 18/544,095

(22) Filed: Dec. 18, 2023

(51) Int. Cl. G09B 7/02; G06N 3/08

(52) U.S. Cl. CPC G09B 7/02; G06N 3/08

(57) ABSTRACT

Described herein are systems and methods for synchronous learning. In some embodiments, an apparatus may receive a discussion topic, such as a topic for students to discuss in a classroom group environment. A prompt may be generated and communicated to students based on this discussion topic. Student discussion of the prompt may be analyzed, and student attributes may be evaluated.

### FIELD OF THE INVENTION

The present invention generally relates to the field of artificial intelligence. In particular, the present invention is directed to systems and methods for generating a user attribute score.

### BACKGROUND

Very little has been successfully done on automatedly assessing student attributes in a free form conversation setting. This is in part due to the difficulty of isolating contributions of particular students, and accounting for variation in behavior of other students when assessing a particular student. For example, not every conversation in a free form setting will reliably produce sufficient data on every student of interest. This makes it difficult to reliably evaluate students based on discussions without needing to go back and re-evaluate students, which may cause hassle and take valuable class time. Additionally, forming optimal student groups in order to facilitate discussions can be difficult. Individual characteristics of students make it difficult to predict which groups will allow students to learn best.

### SUMMARY OF THE DISCLOSURE

In an aspect, an apparatus for generating a user attribute score may include at least a processor; and a memory communicatively connected to the at least processor, the memory containing instructions configuring the at least processor to present to a first user a first prompt by transmitting to a first user device a first signal, wherein the first signal configures the first user device to display the first prompt; receive from the first user device a first discussion datum, wherein the first discussion datum comprises a response by the first user to the first prompt; and generate a first user attribute score as a function of the first discussion datum by training an attribute generation machine learning model on a training dataset including example discussion data associated with example user attribute scores; inputting the first discussion datum into the attribute generation machine learning model; and receiving, as an output, from the attribute generation machine learning model, the first user attribute score.

In another aspect, a method of generating a user attribute score may include using at least a processor, presenting to a first user a first prompt by transmitting to a first user device a first signal, wherein the first signal configures the first user device to display the first prompt; using at least a processor, receiving from the first user device a first discussion datum, wherein the first discussion datum comprises a response by the first user to the first prompt; and using at least a processor, generating a first user attribute score as a function of the first discussion datum by training an attribute generation machine learning model on a training dataset including example discussion data associated with example user attribute scores; inputting the first discussion datum into the attribute generation machine learning model; and receiving, as an output, from the attribute generation machine learning model, the first user attribute score.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram depicting an exemplary apparatus for synchronous learning;

FIG. 2 is a diagram depicting an exemplary machine learning model;

FIG. 3 is a diagram depicting an exemplary neural network;

FIG. 4 is a diagram depicting an exemplary neural network node;

FIG. 5 is a diagram depicting an exemplary chatbot system;

FIG. 6 is a diagram depicting an exemplary method of synchronous learning; and

FIG. 7 is a block diagram of a computing system that can be used to implement any one or more of the methodologies disclosed herein and any one or more portions thereof.

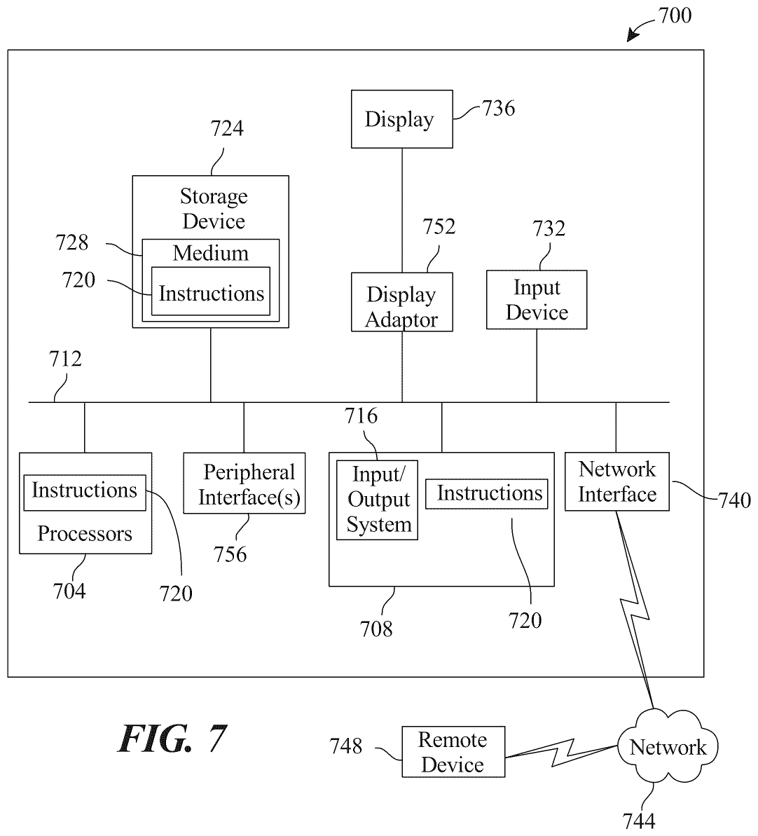

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for synchronous learning. An apparatus may receive a discussion topic, such as a discussion topic for students to discuss in a classroom environment. Discussion topic may be provided by an instructor. Apparatus may generate a prompt as a function of discussion topic. Prompt may be communicated to one or more users, such as students. Prompt may be communicated to students while they are in breakout rooms in an online class environment. Prompt may direct students to discuss a particular topic, such as a topic students have been studying. Apparatus may collect discussion datum from student discussion of prompt. Discussion datum may include an audio recording of student conversation. Apparatus may interpret such audio data using machine learning techniques, such as through use of a speech recognition model and/or a language model. Apparatus may score student attributes based on the output of such machine learning models. Apparatus may detect situations in which data is likely to be insufficient to score student understanding, such as when a particular student is silent; in such a situation, apparatus may generate and communicate to students a follow up prompt, directing the student in question to speak. Apparatus may communicate student attribute scores to instructor.

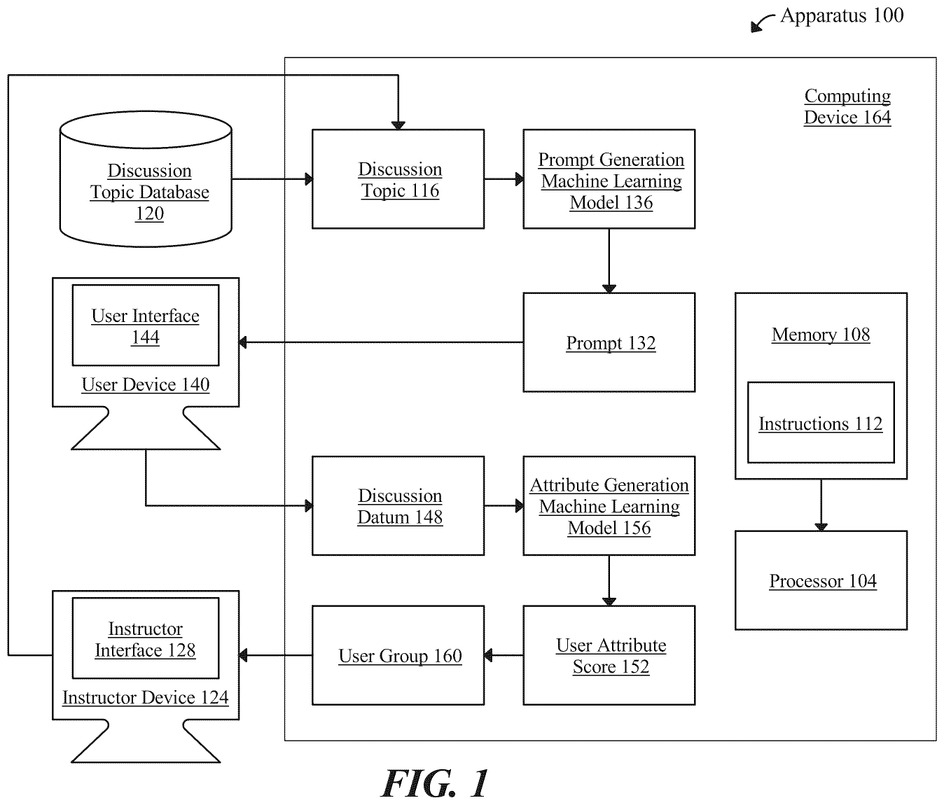

Referring now to FIG. 1, an exemplary embodiment of an apparatus 100 for synchronous learning is illustrated. Apparatus 100 may include computing device 164. Apparatus 100 may include a processor. Processor may include, without limitation, any processor described in this disclosure. Processor may be included in a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, apparatus 100 may include computing device 164. In some embodiments, computing device 164 may include at least a processor 104 and a memory 108 communicatively connected to the at least a processor 104, the memory 108 containing instructions 112 configuring the at least a processor 104 to perform one or more processes described herein. Computing devices including memory 108 and at least a processor 104 are described in further detail herein.

Still referring to FIG. 1, as used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, in some embodiments, apparatus 100 may receive discussion topic 116. As used herein, a “discussion topic” is a subject for users to discuss. For example, discussion topic 116 may include a particular chapter from a book, a particular mathematical concept, a particular historical figure, or the like. Apparatus 100 may receive discussion topic 116 from discussion topic database 120. For example, discussion topic database may include an academic syllabus, which apparatus 100 may retrieve and analyze in order to determine an appropriate discussion topic 116 for a particular class session.

Still referring to FIG. 1, a database such as discussion topic database 120 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Still referring to FIG. 1, in some embodiments, a file such as a syllabus may be analyzed in order to determine discussion topic 116 using machine learning techniques such as a language model as described further herein. In some embodiments, apparatus 100 may receive discussion topic 116 from instructor device 124. Instructor device 124 may include, for example, a smartphone, smartwatch, tablet, or computer. Instructor device 124 may include instructor interface 128. Instructor interface 128 may include an input interface and/or an output interface. Input interface of instructor interface 128 may include, for example, a mouse, keyboard, touchscreen, button, scroll wheel, controller, microphone, camera, and the like. Output interface of instructor interface 128 may include, for example, a screen, speaker, and the like. An interface may include a graphical user interface (GUI). In some embodiments. an interface may be configured to prompt a user for an input. In a non-limiting example, an interface may request that a user input discussion topic 116 and/or a syllabus. In some embodiments, apparatus 100 may obtain discussion topic 116 through a physical or digital form such as a form on a website. For example, an instructor may scan a physical syllabus, and the physical syllabus may be analyzed using optical character recognition techniques in order to convert the scanned syllabus into a machine readable format such as text; a language model may then be used to interpret the syllabus and determine a discussion topic. In another example, an instructor may input discussion topic 116 into a form on a website. In another example, an instructor may verbally express that tomorrow's class will be about a certain historical figure, and apparatus 100 may detect this speech using a microphone, transcribe the speech using an automatic speech recognition system, then use a language model to interpret the speech and determine discussion topic 116. In another example, an instructor may write on a whiteboard that tomorrow's class will be about a certain chemical process, and apparatus 100 may use a camera to detect the writing, use an optical character recognition system to transcribe the writing, and use a language model to interpret the writing and determine discussion topic 116.

Still referring to FIG. 1, in some embodiments, instructor may approve, reject, modify and/or replace discussion topic 116. For example, apparatus 100 may suggest to instructor discussion topic 116 based on what instructor wrote on a whiteboard, and instructor may approve the suggested discussion topic 116. In another example, apparatus 100 may suggest to instructor discussion topic 116 and instructor may reject it and input a substitute.

Still referring to FIG. 1, in some embodiments, variables described herein may be converted into different forms. Data formats may be converted in a variety of ways, such as without limitation, using a speech to text function or using optical character recognition. In some embodiments, a variable such as discussion topic 116 may be converted into a different form such that it is in a form appropriate for input into a function. As a non-limiting example, a machine learning model that accepts discussion topic 116 as an input may only accept inputs in a particular format, and discussion topic 116 may be converted into that format such that it may be effectively input into the machine learning model. For example, discussion topic 116 may be on a physical syllabus scanned by an instructor. Apparatus 100 may use optical character recognition techniques to read the syllabus, and may use another machine learning model, such as a language model, to interpret the syllabus and identify discussion topic 116.

Still referring to FIG. 1, data may also be altered such that it retains the same format but is more likely to produce successful or relevant results. As a non-limiting example, a machine learning model may be used to replace obscure words in a text file with more common words that have similar or identical meanings. In this example, this may be done by training a machine learning model on samples of text using unsupervised learning such that the machine learning model learns associations between words (such as based on how frequently they are used together). In this example, words may be represented as vectors with dimensions indicating their relationship to other words, and whether words are synonyms may be determined based on how similar their vectors are (as in, if vectors representing 2 words point in the same direction, those words may be synonyms). In this example, a first word determined to be similar to or a synonym of a second word, may be replaced by the second word.

Still referring to FIG. 1, in some embodiments, discussion topic 116 may be determined using OCR. For example, discussion topic 116 may be determined from a syllabus in image format, and OCR may be used to identify text from the image. In another example, discussion topic 116 may be determined from writing on a whiteboard or chalkboard, or slides an instructor presents to a class. In these examples, OCR may also be used to identify text from the image, and further techniques such as language models may be used to interpret the text and determine discussion topic 116.

Still referring to FIG. 1, in some embodiments, optical character recognition or optical character reader (OCR) includes automatic conversion of images of written (e.g., typed, handwritten or printed text) into machine-encoded text. In some cases, recognition of at least a keyword from image data may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine-learning processes. In some cases, intelligent word recognition (IWR) may recognize written text, one word at a time, for instance by employing machine-learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information may make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image data. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image data to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image data. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image data.

Still referring to FIG. 1, in some embodiments an OCR process may include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of image data. Matrix matching may also rely on a stored glyph being in a similar font and at a same scale as input glyph. Matrix matching may work best with typewritten text.

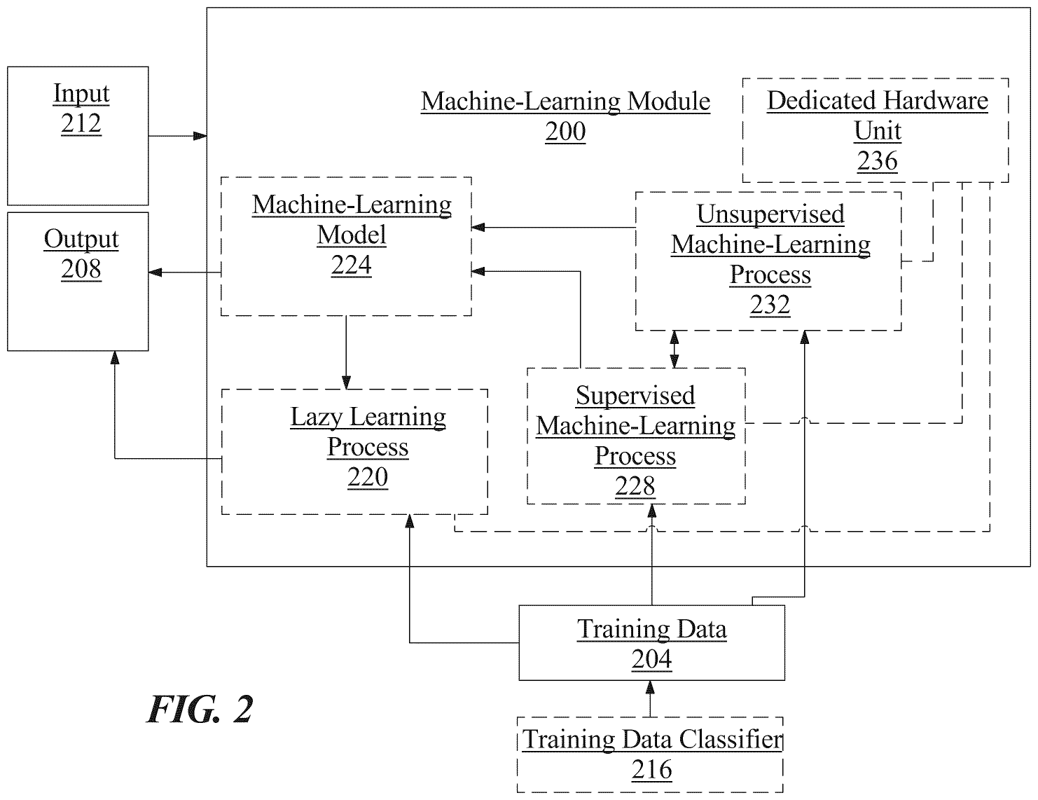

Still referring to FIG. 1, in some embodiments, an OCR process may include a feature extraction process. In some cases, feature extraction may decompose a glyph into at least a feature. Exemplary non-limiting features may include corners, edges, lines, closed loops, line direction, line intersections, and the like. In some cases, feature extraction may reduce dimensionality of representation and may make the recognition process computationally more efficient. In some cases, extracted feature may be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) may be used to compare image features with stored glyph features and choose a nearest match. OCR may employ any machine-learning process described in this disclosure, for example machine-learning processes described with reference to FIGS. 2-4. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. A first pass may try to recognize a character. Each character that is satisfactory is passed to an adaptive classifier as training data. The adaptive classifier then gets a chance to recognize characters more accurately as it further analyzes image data. Since the adaptive classifier may have learned something useful a little too late to recognize characters on the first pass, a second pass is run over the image data. Second pass may include adaptive recognition and use characters recognized with high confidence on the first pass to recognize better remaining characters on the second pass. In some cases, two-pass approach may be advantageous for unusual fonts or low-quality image data. Another exemplary OCR software tool include OCRopus. OCRopus development is led by German Research Centre for Artificial Intelligence in Kaiserslautern, Germany. In some cases, OCR software may employ neural networks.

Still referring to FIG. 1, in some cases, OCR may include post-processing. For example, OCR accuracy may be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of image data. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Still referring to FIG. 1, in some embodiments, discussion topic 116 may be determined using an automatic speech recognition system. For example, an instructor may verbally express to a class that the next subject will be a particular topic in physics and related equations. Apparatus 100 may detect such speech using a microphone, transcribe the speech using an automatic speech recognition system, and interpret the speech and determine discussion topic 116 using a language model. In some embodiments, an automatic speech recognition system may be used to transcribe a datum such as discussion topic 116 or discussion datum 148 into machine-readable text.

Still referring to FIG. 1, in some embodiments, speech data may be processed using automatic speech recognition. In some embodiments, automatic speech recognition may require training (i.e., enrollment). In some cases, training an automatic speech recognition model may require an individual speaker to read text or isolated vocabulary. In some cases, training data may include an audio component having an audible verbal content, the contents of which are known a priori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within speech data, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum aposteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

Still referring to FIG. 1, in some embodiments, an automatic speech recognition process may include a neural network. Neural network may include any neural network, for example those disclosed with reference to FIGS. 2-4. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 1, in some embodiments, a language model may be used to process language, such as language extracted from a syllabus, transcribed from speech by an instructor, or transcribed from handwriting of an instructor. In some embodiments, a language model may be used to determine discussion topic 116. As used herein, a “language model” is a program capable of interpreting natural language, generating natural language, or both. In some embodiments, a language model may be configured to interpret the output of an automatic speech recognition function and/or an OCR function. A language model may include a neural network. A language model may be trained using a dataset that includes natural language.

Still referring to FIG. 1, generating language model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, processor 104 may determine one or more language elements in language data by identifying and/or detecting associations between one or more language elements (including phonemes or phonological elements, morphemes or morphological elements, syntax or syntactic elements, semantics or semantic elements, and pragmatic elements) extracted from at least user data and/or response, including without limitation mathematical associations, between such words. Associations between language elements and relationships of such categories to other such term may include, without limitation, mathematical associations, including without limitation statistical correlations between any language element and any other language element and/or Language elements. Processor 104 may compare an input such as a sentence from language data with a list of keywords or a dictionary to identify language elements. For example, processor 104 may identify whitespace and punctuation in a sentence and extract elements comprising a string of letters, numbers or characters occurring adjacent to the whitespace and punctuation. Processor 104 may then compare each of these with a list of keywords or a dictionary. Based on the determined keywords or meanings associated with each of the strings, processor 104 may determine an association between one or more of the extracted strings and a feature of an element of language, such as an association between a short sequence of text containing a date, a colon, and a topic as an indication that the topic is to be discussed on the date. Associations may take the form of statistical correlations and/or mathematical associations, which may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory.

Still referring to FIG. 1, processor 104 may be configured to determine one or more language elements in language data using machine learning. For example, processor 104 may generate the language processing model by any suitable method, including without limitation a natural language processing classification algorithm; language processing model may include a natural language process classification model that enumerates and/or derives statistical relationships between input terms and output terms. An algorithm to generate language processing model may include a stochastic gradient descent algorithm, which may include a method that iteratively optimizes an objective function, such as an objective function representing a statistical estimation of relationships between terms, including relationships between input language elements and output patterns or conversational styles in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrase, and/or other semantic unit. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Still referring to FIG. 1, processor 104 may be configured to determine one or more language elements in language data using machine learning by first creating or receiving language classification training data. Training data may include data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below.

Still referring to FIG. 1, language classification training data may be a training data set containing associations between language element inputs and associated language element outputs. Language element inputs and outputs may be categorized by communication form such as written language elements, spoken language elements, typed language elements, or language elements communicated in any suitable manner. Language elements may be categorized by component type, such as phonemes or phonological elements, morphemes or morphological elements, syntax or syntactic elements, semantics or semantic elements, and pragmatic elements. Associations may be made between similar communication types of language elements (e.g. associating one written language element with another written language element) or different language elements (e.g. associating a spoken language element with a written representation of the same language element). Associations may be identified between similar communication types of two different language elements, for example written input consisting of the syntactic element “that” may be associated with written phonemes /th/, /ã/, and /t/. Associations may be identified between different communication forms of different language elements. For example, the spoken form of the syntactic element “that” and the associated written phonemes above. Language classification training data may be created using a classifier such as a language classifier. An exemplary classifier may be created, instantiated, and/or run using processor 104, or another computing device. Language classification training data may create associations between any type of language element in any format and other type of language element in any format. Additionally, or alternatively, language classification training data may associate language element input data to a feature related to a class. For example, language classification training data may associate occurrences of the syntactic elements “read,” “Hamlet” and “act 1” in a single sentence with the feature of Hamlet act 1 being a discussion topic option.

Still referring to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)−P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

Still referring to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿ aᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 1, in some embodiments, processor 104 may identify certain aspects of data to input into a language model in order to determine discussion topic 116. For example, a syllabus may include a table with columns for date and assigned reading; in this example, processor may determine discussion topic 116 for a particular date by inputting the description of the assigned reading for the relevant date into a language model and receiving an output.

Still referring to FIG. 1, in some embodiments, apparatus 100 may generate a prompt 132 as a function of discussion topic 116. As used herein, a “prompt” is language designed to cause a user to speak. In some embodiments, apparatus 100 may generate prompt 132 by looking up a list of prompts associated with a particular discussion topic from a database. Databases are described above. Prompts may be ranked in order of priority, categorized as being appropriate in certain situations, and the like. For example, if discussion topic 116 is how to calculate the resulting velocity of each object after multiple objects collide, then a first prompt may be designated as a prompt to open a discussion with and may direct users, such as students, to solve a particular problem, and a second prompt may be designated as a prompt to be used if the users are stuck and may direct the users to identify certain values to be used in a relevant equation and plug them in.

Still referring to FIG. 1, in some embodiments, apparatus 100 may generate prompt 132 using a machine learning model such as prompt generation machine learning model 136. Prompt generation machine learning model 136 may use a machine learning algorithm described herein, such as a supervised learning algorithm, an unsupervised learning algorithm, a reinforcement learning algorithm, and the like. In some embodiments, prompt generation machine learning model 136 may include a neural network model. In some embodiments, prompt generation machine learning model 136 may include a language model. In some embodiments, a supervised learning algorithm and a training dataset are used to train prompt generation machine learning model 136; such training dataset may include model discussion topics, associated with example prompts. Such training data may be gathered by, for example, reviewing historical teaching documents such as assigned readings and homework questions based on those readings; in this example, a historical assigned reading and/or the core subject matter of a historical assigned reading may be used as an example discussion topic, and a historical question asked based on the assigned reading, such as a homework question or an in class essay question, may be used as an example prompt. Training data may also be generated by gathering questions from sources such as academic exams or standardized tests and matching them to related subject matter. Training data may also be generated by gathering questions from textbooks and determining topics to be associated with those questions based on the content of the section of the book that the question is focused on (for example, by inputting such content into a language model). Once prompt generation machine learning model 136 has been trained, it may be used to generate prompt 132. This may be done by inputting discussion topic 116 into prompt generation machine learning model 136 and receiving, as an output, prompt 132.

Still referring to FIG. 1, in some embodiments, prompt generation machine learning model 136 may accept as an additional input a context datum. In some embodiments, a context datum include an amount of time in a discussion session and/or the amount of time remaining in a discussion session. In some embodiments, a context datum may include a datum indicating whether a particular user, such as a student, has spoken up yet and/or generated sufficient data to be evaluated. In some embodiments, a context datum may include a datum indicating how difficult the prompt should be. For example, a first input into prompt generation machine learning model 136 may include discussion topic 116 and a context datum indicating the need for a general question on discussion topic 116, then during a discussion section, if a particular user has not yet spoken, a second input into prompt generation machine learning model 136 may include discussion topic 116 and an indication that the question should be directed at a particular user. In this example, a second prompt may be based on the output from prompt generation machine learning model 136 and may be directed at the silent user in order to get them to speak. In another example, a first input into prompt generation machine learning model 136 may include discussion topic 116 and a context datum indicating the need for a general question on discussion topic 116, then during a discussion section, if the users appear to have a solid understanding of the subject matter and/or have solved a question posed to them, then a second input into prompt generation machine learning model 136 may include discussion topic 116 and an indication that a question with a particular difficulty is needed. In this example, a second prompt may be based on the output from prompt generation machine learning model 136 and may be more challenging than the first prompt.

Still referring to FIG. 1, prompt generation machine learning model 136 that accepts as an input a context datum may be trained on a training dataset that includes example context data. For example, such training data may include discussion topic 116 based on historical syllabus and context datum based on the grade of the users for which that syllabus was designed, and this may be associated with homework questions asked of those users based on the relevant section of the syllabus.

Still referring to FIG. 1, follow up prompts may be generated based on analysis of an ongoing discussion responding to a prompt. Methods of detecting and analyzing discussion are described in more detail herein and include detecting discussion using a microphone, using an automatic speech recognition system to identify speakers and/or transcribe speech, and using an attribute generation machine learning model to identify a user attribute score and/or a certainty score. In some embodiments, a follow up prompt may be generated in order to improve the data available to apparatus 100 for evaluating user attributes. For example, if apparatus 100 has enough data to evaluate 4 of 5 users in a group based on discussion in response to an initial prompt, then apparatus 100 may generate a second prompt directed at the remaining user in order to gather more data on that user. Whether apparatus 100 has enough data to properly evaluate a user's attributes may be based on a certainty score, which may be evaluated during a discussion between users based on the first part of the discussion. For example, apparatus 100 may generate a follow up prompt based on a comparison between a certainty score and a certainty score threshold. Certainty scores are discussed in further detail below.

Still referring to FIG. 1, in some embodiments, prompt generation machine learning model 136 may be trained using a reinforcement learning algorithm. For example, prompt generation machine learning model 136 may be used to generate a prompt, and an instructor may approve or deny the prompt. Apparatus 100 may use the instructor's approval or denial of the prompt to train prompt generation machine learning model 136. For example, prompt generation machine learning model 136 may be trained using a reinforcement learning mechanism in which prompt generation machine learning model 136 receives discussion topic 116 as an input, generates a prompt as an output, and receives feedback in the form of a cost function, where high cost function values dissuade prompt generation machine learning model 136 from producing similar outputs in the future and low cost function values encourage prompt generation machine learning model 136 to produce similar outputs in the future. Instructor approval of a prompt may cause apparatus 100 to determine a low cost, whereas instructor denial of a prompt may cause apparatus 100 to determine a high cost in this context. In some embodiments, costs are determined based on a resulting certainty score. For example, outputs that result in low certainty scores may be assigned high costs, while outputs that result in high certainty scores may be assigned low costs.

Still referring to FIG. 1, in some embodiments, apparatus 100 may present to a user prompt 132. In some embodiments, apparatus 100 may present to a user (such as a student) prompt 132 by sending a signal to user device 140, where the signal configures user device 140 to communicate prompt 132 to the user. As used herein, a “user device” is a device operated by a user. In some embodiments, user device 140 may communicate prompt 132 to a user through user interface 144. User device 140 and/or user interface 144 may have one or more properties described with reference to instructor device 124 and instructor interface 128. For example, user device 140 may include a smartphone, tablet, smartwatch, computer, and the like. For example, user interface 144 may include a screen, speaker, and the like.

Still referring to FIG. 1, in some embodiments, apparatus 100 may present the same prompt 132 to multiple users, such as all users in a class. In some embodiments, apparatus 100 may organize users into groups and present prompt 132 to members of a group. This may be done, for example, to facilitate discussion in small groups where each user has sufficient opportunity to speak. In some embodiments, this may aid in generating sufficient data for evaluating each user. Organizing users into groups may include, for example, dividing them into breakout rooms in an online class environment using online meeting software. Groups may be determined, for example, randomly, based on instructor assignments, based on user behavior (such as to avoid creating disruptive user combinations), based on user scores in previous sessions, or based on which users talk more on average across multiple sessions.

Still referring to FIG. 1, in some embodiments, apparatus 100 may allow users to discuss prompt 132. This discussion may be allowed to proceed for a set period of time, such as the duration of a class, or half the duration of a class. A set period of time may be input by an instructor, determined from a syllabus, or the like. An instructor may be able to observe user discussion based on prompts. For example, instructor may be able to select a user group to observe and may listen in on their conversation and/or discuss prompt 132 with members of the group.

Still referring to FIG. 1, in some embodiments, apparatus 100 may receive discussion datum 148. In some embodiments, discussion datum 148 may comprise a user response to prompt 132. As used herein, a “discussion datum” is a recording of a user response to a prompt, a user input in response to a prompt, a datum derived from a recording of a user response to a prompt, a datum derived from a user input in response to a prompt, or a combination thereof. Apparatus 100 may record discussion datum 148 using a microphone, such as a microphone that is part of user device 140. In some embodiments, apparatus 100 may record discussion datum 148 by receiving or recording conversation transmitted through a meeting app.

Still referring to FIG. 1, discussion datum 148 may be transcribed using an automatic speech recognition system as described above. Apparatus 100 may attribute statements within discussion datum 148 to individual speakers using an automatic speech recognition system as described above. Apparatus 100 may interpret discussion datum 148 using a machine learning model such as a language model as described above. In some embodiments, apparatus 100 may first transcribe discussion datum 148 and attribute statements to speakers using an automatic speech recognition system, then interpret statements within discussion datum 148 using a machine learning model such as a language model.

Still referring to FIG. 1, in some embodiments, apparatus 100 may also record visual information relating to user discussion, such as a video of user discussion. This may be used alongside a machine vision system to, for example, identify speakers. For example, a machine vision system may detect which user appears to be speaking at a variety of time points in a video of a discussion between users, and apparatus 100 may use this information to attribute statements within an audio recording to specific users. A machine vision system may utilize data gathered through a camera, such as a camera within user device 140.

Still referring to FIG. 1, in some embodiments, apparatus 100 may include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it refers to generation and/or formation of an image.

Still referring to FIG. 1, in some embodiments, apparatus 100 may include a machine vision system. In some embodiments, a machine vision system may include at least a camera. A machine vision system may use images, such as images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 1, an exemplary machine vision camera is an OpenMV Cam H7 from OpenMV, LLC of Atlanta, Georgia, U.S.A. OpenMV Cam comprises a small, low power, microcontroller which allows execution of machine vision applications. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 1, apparatus 100 may generate user attribute score 152. In some embodiments, apparatus 100 may generate user attribute score 152 as a function of discussion datum 148. In some embodiments, apparatus 100 may generate user attribute score 152 as a function of discussion topic 116. In some embodiments, apparatus 100 may generate user attribute score 152 as a function of prompt 132. As used herein, a “user attribute score” is an evaluation of an attribute of a user. User attribute scores may evaluate, as non-limiting examples, focus, preparedness, a degree to which a user takes the initiative, disruptiveness, leadership, enthusiasm, talkativeness, creativity, and the like. In some embodiments, user attribute score 152 may be qualitative, such as a categorization as to whether or not a user has leadership qualities. In some embodiments, user attribute score 152 may be quantitative, such as a measurement of the degree to which a user has leadership qualities.

Still referring to FIG. 1, in some embodiments, apparatus 100 may generate user attribute score 152 using attribute generation machine learning model 156. Attribute generation machine learning model 156 may use a machine learning algorithm described herein, such as a supervised learning algorithm, an unsupervised learning algorithm, a reinforcement learning algorithm, and the like. In some embodiments, attribute generation machine learning model 156 may include a neural network model. In some embodiments, attribute generation machine learning model 156 may include a language model. In some embodiments, a supervised learning algorithm and a training dataset are used to train attribute generation machine learning model 156; such training dataset may include example discussion data, associated with example user attribute scores. Such training data may be obtained by, for example, gathering historical recordings of discussions in an academic context, viewing those recordings, and assigning ratings to attributes of discussion participants based on human perception of those attributes. In another example, training data may be obtained by gathering historical recordings of discussions in an academic context, and written evaluations of students in the discussion; written evaluations may contain information on attributes of the students, and these attributes may be automatedly interpreted from the written evaluations using a language model. Similarly, attribute generation machine learning model 156 may be trained on a training dataset including example prompts and/or example discussion topics in addition to example discussion data and example user attribute scores. Training attribute generation machine learning model 156 using example prompts and/or example discussion topics may be useful to, for example, determine a user attribute score 152 associated with how focused a user is. Example prompts and/or example discussion topics may be gathered by, for example, from a syllabus or assignment relevant to a discussion recording. In another example, training data may be gathered by posing prompts to users, receiving responses, and having instructors evaluate user attributes based on those responses. Once attribute generation machine learning model 156 is trained, it may be used to generate user attribute score 152. In some embodiments, apparatus 100 may input into attribute generation machine learning model 156 discussion datum 148 and may receive user attribute score 152 or a datum used to determine user attribute score 152 as an output. In some embodiments, attribute generation machine learning model 156 inputs may also include discussion topic 116 and/or prompt 132.

Still referring to FIG. 1, in some embodiments, attribute generation machine learning model 156 may include a classifier. For example, attribute generation machine learning model 156 may be trained on a dataset including example discussion data, associated with example categorizations as to whether or not discussion participant has a particular attribute. Such categorizations may be gathered by, for example, human review of example discussion data or language model analysis of historical written evaluations. Attribute generation machine learning model 156 including a classifier may accept as an input discussion datum 148 and may classify a user into a category associated with whether the user has a particular attribute as an output.

Still referring to FIG. 1, in some embodiments, data may be prepared for attribute generation machine learning model 156 using an automatic speech recognition system. Automatic speech recognition systems are described above. Automatic speech recognition system may be used to transcribe audio discussion datum 148 into a machine readable format such as a text format. Automatic speech recognition system may be used to attribute elements of speech to particular users.

Still referring to FIG. 1, in some embodiments, apparatus 100 may modify an output of attribute generation machine learning model 156 in order to determine user attribute score 152. For example, attribute generation machine learning model 156 may receive as an input discussion datum 148 and may output a datum describing a user's level of preparation. However, expectations for users may differ such that further data may be needed in order to determine an appropriate user attribute score 152. For example, a 7^{th} grader, a high school junior, and a college senior may all discuss a particular historical figure, but the expectation for the preparation of the college senior may be higher than that of the high school junior, and much higher than that of the 7^{th} grader. If each of these users receive the same output from attribute generation machine learning model 156, then their user attribute scores 152 may differ according to their expectations. In this example, the user attribute score 152 for the preparation of the college senior may be low, that of the high school junior may be average, and that of the 7^{th} grader may be high. Apparatus 100 may apply one or more thresholds to the output of attribute generation machine learning model 156 in order to determine user attribute score 152. In some embodiments, a grading threshold may be set by an instructor. In some embodiments, a threshold may be set by an institution such as an academic institution. In some embodiments, a threshold may be recommended to an instructor by apparatus 100 and the instructor may have the option to accept the recommended threshold or set their own. In some embodiments, a threshold may be determined based on a syllabus or other data input by an instructor and/or institution. In some embodiments, a threshold may be determined or recommended to an instructor based on the demographics or other characteristics of the user. For example, a threshold may be determined based on the grade of the user being evaluated, the age of the user being evaluated, the gender of the user, and whether a user is a native speaker of a language being used in the discussion.

Still referring to FIG. 1, in some embodiments, a user attribute score 152 and/or a threshold may be determined based on outputs from attribute generation machine learning model 156 for a plurality of users, such as a class, group, or multiple classes. For example, user attribute score 152 may be determined as a percentile rank among users in the class, based on the output of attribute generation machine learning model 156 for each user in the class. For example, members of a class may be ranked according to how prepared they are, how focused they are, how disruptive they are, and the like. In another example, user attribute score may be determined based on the output of attribute generation machine learning model 156 for all users taking a class in a school district, all users who have taken a class within the past 5 years, and the like. In some embodiments, user attribute scores 152 are stored for future retrieval in order to create such metrics in the future. User attribute scores may be stored, for example, in a database.

Still referring to FIG. 1, in some embodiments, apparatus 100 may determine a certainty score. In some embodiments, attribute generation machine learning model 156 may output a certainty score in addition to user attribute score 152. As used herein, a “certainty score” is a degree of confidence in a measure of an attribute of a user. A certainty score may indicate low confidence when, in non-limiting examples, a user has not spoken in a particular discussion session, a user's microphone is muted for a majority of the discussion session, and/or a user's camera is off for a majority of the discussion session. Additional examples of scenarios where certainty scores may indicate low confidence include situations in which user responses are short or incomprehensible. A certainty score may indicate high confidence where, for example, a user has given a thorough response to a question and/or discussion datum 148 produced by that user fits well into a training data pattern indicating a particular user attribute score 152. For example, attribute generation machine learning model 156 may include a classifier designed to categorize users according to their degree of preparedness for a particular topic, and attribute generation machine learning model 156 may be designed to output a low certainty score where it is less clear which category to assign a user to. In some embodiments, attribute generation machine learning model 156 may assign certainty scores based on, for example, how closely discussion datum 148 matches a pattern in training data or an evaluation of a percent chance of a particular result (as may be calculated in certain classification algorithms for example).

Still referring to FIG. 1, in some embodiments, attribute generation machine learning model 156 may be used to generate follow up prompts. For example, attribute generation machine learning model 156 may be used to periodically calculate certainty scores for users participating in a discussion. If, after a certain period of time, a certainty score for a particular user remains low, apparatus 100 may generate a new prompt 132 directed at the user with the low certainty score and may communicate the new prompt 132 to the user and/or a group that the user is in. In some embodiments, this may minimize the occurrence of scenarios in which there is not enough data to evaluate the attributes of certain users with a high degree of confidence. In some embodiments, this may get around problems in which a system does not consistently have enough data to evaluate each user's attributes with high confidence, and it is not clear that this will be a problem for any particular user before the discussion.

Still referring to FIG. 1, in some embodiments, user attribute score 152 may be determined by applying machine vision techniques to discussion datum 148. For example, a focus attribute may be determined based on the percentage of the time a user looks at a screen. For example, a focus attribute may be determined based on the percentage of the time a user looks at a screen while another user is talking. This may be determined by applying machine vision techniques to discussion datum 148 including video data. For example, eye tracking techniques may be used. Machine vision is described above. In another example, a machine learning model may be used to identify facial expressions and/or body language. Such a machine learning model may be trained on a dataset including video or image data, associated with an emotion, body language feature and/or expression of an individual depicted in the video or image data. Such a dataset may be gathered by, for example, recording videos or capturing images of discussions, and having a panel of humans assign features to those videos or images. Such a machine learning model may accept as an input discussion datum 148 including video or image data and may output a datum describing an emotion, body language feature and/or expression depicted. In some embodiments, such a machine learning model may include a classifier. In some embodiments, a convolutional neural network may be used. A convolutional neural network may be able to detect features in certain regions of an image and create a feature map in a hidden layer of the convolutional neural network. For example, convolutional neural network may detect edges in a feature map. Additional layers of the network may convert this feature map into an output indicating whether, or the degree to which, certain reactions are present. In some embodiments, a machine vision model that is tolerant to translation of a set of features from one part of an image to another may be selected. Selecting such a model may allow a machine vision system to, for example, recognize a certain facial expression regardless of where the face is in the frame. In some embodiments, a convolutional neural network tolerant to such translation may be used.

Still referring to FIG. 1, in some embodiments, user attribute score 152 may be determined using a language model. For example, a language model may be used to interpret discussion datum 148 and detect when new information is presented in a discussion, and a preparedness attribute may be determined based on this language model output.

Still referring to FIG. 1, in some embodiments, user attribute score 152 may be determined based on a transcript of discussion datum 148 generated using an automatic speech recognition system. For example, processor 104 may determine a number of words spoken by a user in a discussion and may determine a social attribute as a function of word count.

Still referring to FIG. 1, in some embodiments, user attribute score 152 may be determined based on the availability of data relating to a particular user. For example, processor 104 may determine a percent of time a user has a microphone muted or a camera turned off, and these may be used to determine a focus attribute.

Still referring to FIG. 1, in some embodiments, user attribute score 152 may be determined based on the timing of user speech in discussion datum 148. For example, an automatic speech recognition system may be used to transcribe discussion datum 148, and a disruptiveness attribute may be modified if multiple users talk simultaneously. This may be found, for example, where an automatic speech recognition system produces a transcript including a section in which the speaker frequently changes without complete thoughts having been communicated first.

Still referring to FIG. 1, in some embodiments, user attribute score 152 may be determined based on a user attribute score of another participant in a discussion. For example, if a discussion as a whole is more focused and/or on topic than is typical of other users participating in a discussion, then a user may be assigned a high rating for a leadership attribute. The degree to which a discussion is on topic may be determined as described in the context of group attribute scores below.

Still referring to FIG. 1, in some embodiments, user attribute score 152 may be determined as a function of content received in a non-audio format. For example, a user may type an answer in a chat window, and this may be evaluated as a transcribed discussion datum.

Still referring to FIG. 1, in some embodiments, user attribute score 152 may take into account data from multiple discussions. For example, users may participate in several discussions, apparatus 100 may receive discussion datum 148 from each discussion, and apparatus 100 may generate user attribute score 152 based on an average rating of a particular user over the several discussions. In some embodiments, user attribute score 152 may be generated based more heavily on discussions for which apparatus 100 has collected better relevant data, such as discussions for which a certainty score is higher. In some embodiments, user attribute score 152 may be calculated based on a first discussion and may be modified based on further discussions. In some embodiments, apparatus 100 may store a plurality of discussion data 148 related to multiple discussions and may recalculate user attribute score 152 based on the entire data set as new data is added. In some embodiments, certainty score may be specific to data from a particular discussion. In some embodiments, certainty score may indicate an overall confidence level based on data from a plurality of discussions.

Still referring to FIG. 1, apparatus 100 may generate a group attribute score. As used herein, a “group attribute score” is an evaluation of an attribute of a group of two or more participants in the same discussion. Exemplary group attributes include focus, the degree to which each student has a chance to speak, discussion depth, discussion length, and the like. In some embodiments, group attribute score may be generated as a function of discussion datum 148, discussion topic 116, and/or prompt 132.

Still referring to FIG. 1, in some embodiments, apparatus 100 may generate a group attribute score using a group attribute generation machine learning model. A group attribute generation machine learning model may use a machine learning algorithm described herein, such as a supervised learning algorithm, an unsupervised learning algorithm, a reinforcement learning algorithm, and the like. In some embodiments, a group attribute generation machine learning model may include a neural network model. In some embodiments, a group attribute generation machine learning model may include a language model. In some embodiments, a supervised learning algorithm and a training dataset are used to train a group attribute generation machine learning model; such training dataset may include example discussion data, associated with example group attribute scores. Such training data may be obtained by, for example, gathering historical recordings of discussions in an academic context, viewing those recordings, and assigning ratings to attributes of the discussion and/or the discussion participants as a group based on human perception of those attributes. Similarly, a group attribute generation machine learning model may be trained on a training dataset including example prompts and/or example discussion topics in addition to example discussion data and example group attribute scores. Training a group attribute generation machine learning model using example prompts and/or example discussion topics may be useful to, for example, determine a group attribute score associated with how focused a group is. Example prompts and/or example discussion topics may be gathered by, for example, from a syllabus or assignment relevant to a discussion recording. In another example, training data may be gathered by posing prompts to groups, receiving responses, and having instructors evaluate group attributes based on those responses. Once a group attribute generation machine learning model is trained, it may be used to generate a group attribute score. In some embodiments, apparatus 100 may input into a group attribute generation machine learning model discussion datum 148 and may receive a group attribute score or a datum used to determine a group attribute score as an output. In some embodiments, group attribute generation machine learning model inputs may also include discussion topic 116 and/or prompt 132.

Still referring to FIG. 1, a group attribute score may be generated using methods mirroring those described in the context of generating user attribute score 152. For example, automatic speech recognition systems, language models, and machine vision techniques may be used to generate a group attribute score. Certainty scores associated with group attribute scores may also be generated, and questions may be directed at groups of students based on certainty scores. For example, a certainty score associated with group preparedness is low, then apparatus 100 may present to the group prompt 132 asking a question whose answer was in assigned readings. In some embodiments, a group attribute score may take into account data from multiple discussions.

Still referring to FIG. 1, apparatus 100 may determine user group 160 as a function of user attribute score 152. As used herein, a “user group” is two or more users grouped such that they perform an activity together. For example, a user group may identify users grouped together for a follow up discussion. In some embodiments, apparatus 100 may determine user group 160 as a function of user attribute scores 152 of multiple users and/or one or more group attribute scores. A user group may include a plurality of users to be grouped together in a future discussion or other academic exercise. User groups 160 may be determined in order to create user groups 160 with qualities that allow them to discuss topics effectively. For example, grouping a single quiet user with multiple talkative users may result in the quiet user not speaking, which may be seen as a poor result. However, grouping multiple quiet users together may allow space for each of them to talk. As another example, a particular pairing of users may be disruptive, which may be reflected in a group attribute score of a group including those users; such a group may be split up in future discussion sessions in order to avoid this disruptive pairing. As another example, matching students that have diverse attributes together may promote healthy discussion and apparatus 100 may consider attribute diversity as a factor when determining user group 160.

Still referring to FIG. 1, user group 160 may be determined based on user attribute scores determined as a function of the same discussion datum 148 or different ones. For example, user group 160 may be determined based on a first user attribute score describing a first user, based on a first discussion datum received from a first user device, and based on a second user attribute score describing a second user, based on a second discussion datum received from a second user device.

Still referring to FIG. 1, in some embodiments, user group 160 may be determined using a group generation machine learning model. Group generation machine learning model may be trained using reinforcement learning. Group generation machine learning model may generate a group, discussion datum 148 may be collected based on a discussion from this group, and group generation machine learning model based on a cost function associated with discussion datum 148. For example, an average user attribute score 152 associated with user engagement may be converted into a cost function such that group generation machine learning model is trained to generate groups with high engagement. Similarly, group attribute scores may be used to train group generation machine learning model. For example, group generation machine learning model may be trained to optimize a group focus attribute. In some embodiments, a group generation machine learning model may accept as inputs data identifying users and associated user attribute scores, and may output groupings of students. In some embodiments, a group generation machine learning model may be trained using reinforcement learning to optimize a value associated with the entire set of input users. In some embodiments, a group generation machine learning model may be trained using reinforcement learning to optimize a value associated with an average user attribute score 152 associated with an attribute conducive to learning, a minimum user attribute score 152 associated with an attribute conducive to learning, a median user attribute score 152 associated with an attribute conducive to learning, an average group attribute score associated with an attribute conducive to learning, a minimum group attribute score associated with an attribute conducive to learning, a median group attribute score associated with an attribute conducive to learning, or the like. For example, a group generation machine learning model may be trained to optimize an average group attribute score associated with group engagement. Non-limiting examples of user attribute scores 152 and/or group attribute scores which may be optimized include ones associated with engagement, focus, on-topic discussion, quality of discussion, the number or percent of users in a group that participate in a discussion, and the like. In some embodiments, a group generation machine learning model may be trained using reinforcement learning to minimize a value associated with an average user attribute score 152 associated with an attribute not conducive to learning, a maximum user attribute score 152 associated with an attribute not conducive to learning, a median user attribute score 152 associated with an attribute not conducive to learning, an average group attribute score associated with an attribute not conducive to learning, a maximum group attribute score associated with an attribute not conducive to learning, a median group attribute score associated with an attribute not conducive to learning, or the like. For example, a group generation machine learning model may be trained to minimize an average group attribute score associated with disruption. Non-limiting examples of user attribute scores 152 and/or group attribute scores which may be minimized include ones associated with disruption, boredom, apathy, off-topic discussion, aggression, and the like. Using reinforcement learning, group generation machine learning model may improve in group generation over time.

Still referring to FIG. 1, in some embodiments, a clustering algorithm such as a K-means clustering algorithm may be used to generate user group 160. For example, a clustering algorithm may accept as inputs user attribute scores 152 associated with a particular user and may categorize the user as a member of a particular user category as an output. User group 160 may then be determined based on this user category. For example, user group 160 may be determined in order to optimize or minimize user attribute score 152 or a group attribute score. This may be done using reinforcement learning as described above.

Still referring to FIG. 1, in some embodiments, apparatus 100 may be configured to perform one or more steps as described in U.S. patent application Ser. No. 18/543,458, filed on Dec. 18, 2023, and titled “SYSTEMS AND METHODS FOR ARTIFICIAL INTELLIGENCE-MEDIATED MULTIPARTY ELECTRONIC COMMUNICATION,” the entirety of which is hereby incorporated by reference; for example, apparatus 100 may generate a user understanding score and communicate the user understanding score to an instructor as described in this application.

Still referring to FIG. 1, in some embodiments, apparatus 100 may communicate user attribute score 152 and/or user group 160 to an instructor. In some embodiments, apparatus 100 may transmit a signal including user attribute score 152 and/or user group 160 to instructor device 124, and the signal may configure instructor device 124 to communicate user attribute score 152 and/or user group 160 to instructor. Instructor device 124 may communicate user attribute score 152 and/or user group 160 to instructor using, for example, a visual or audio format. Apparatus 100 may communicate a visual element and/or visual element data structure including user attribute score 152 and/or user group 160 to instructor device 124. This may configure instructor device 124 to display a visual element. As used herein, a device “displays” a datum if the device outputs the datum in a format suitable for communication to a user. For example, a device may display a datum by outputting text or an image on a screen or outputting a sound using a speaker. In some embodiments, apparatus 100 may communicate attribute score 152 and/or user group 160 to a remote device. For example, apparatus 100 may communicate attribute score 152 and/or user group 160 to a remote device associated with a social media site.

Still referring to FIG. 1, in some embodiments, a visual element data structure may include a visual element. As used herein, a “visual element” is a datum that is displayed visually to a user. In some embodiments, a visual element data structure may include a rule for displaying visual element. In some embodiments, a visual element data structure may be determined as a function of user attribute score 152. In some embodiments, a visual element data structure may be determined as a function of an item from the list consisting of discussion topic 116, prompt 132, user attribute score 152, and user group 160. In a non-limiting example, a visual element data structure may be generated such that visual element describing or highlighting user attribute score 152 is displayed to a user. For example, an instructor may select a particular user and a particular discussion session, and a visual element depicting user attribute score 152 for a particular user may be displayed. In another example, an instructor may select a particular user and a visual element including a chart showing that user's user attribute scores 152 may be displayed.

Still referring to FIG. 1, in some embodiments, visual element may include one or more elements of text, images, shapes, charts, particle effects, interactable features, and the like. For example, if a user had a particularly high user attribute score for preparedness, then that score may be highlighted and a check mark may be displayed next to it.

Still referring to FIG. 1, a visual element data structure may include rules governing if or when visual element is displayed. In a non-limiting example, a visual element data structure may include a rule causing a visual element describing user attribute score 152 to be displayed when a user selects user attribute score 152 using a GUI.

Still referring to FIG. 1, a visual element data structure may include rules for presenting more than one visual element, or more than one visual element at a time. In an embodiment, about 1, 2, 3, 4, 5, 10, 20, or 50 visual elements are displayed simultaneously.

Still referring to FIG. 1, a visual element data structure rule may apply to a single visual element or datum, or to more than one visual element or datum. A visual element data structure may categorize data into one or more categories and may apply a rule to all data in a category, to all data in an intersection of categories, or all data in a subsection of a category (such as all data in a first category and not in a second category). For example, all user attribute scores 152 that indicate a particular feature (such as disruptiveness) may be displayed in red. A visual element data structure may rank data or assign numerical values to them. For example, greater weightings may be applied to user attribute scores 152 associated with higher certainty scores. A visual element data structure may apply rules based on a comparison between a ranking or numerical value and a threshold. For example, user attribute scores 152 may be organized in a table, with a column of the table indicating a degree of confidence in the relevant user attribute score; in this example, the text “high confidence” in blue may be displayed where a relevant certainty score is above a threshold, and the text “low confidence” in red may be displayed otherwise. Rankings, numerical values, categories, and the like may be used to set visual element data structure rules. Similarly, rankings, numerical values, categories, and the like may be applied to visual elements, and visual elements may be applied based on them. For example, certain visual elements may be designated as higher priority than others. For example, a visual element indicating that a user has a user attribute score 152 indicating that a user is disruptive may take priority over a visual element indicating how frequently the user spoke in the last discussion session.

Still referring to FIG. 1, in some embodiments, visual element may be interacted with. For example, visual element may include an interface, such as a button or menu. In some embodiments, visual element may be interacted with using a user device such as a smartphone.

Still referring to FIG. 1, in some embodiments, apparatus 100 may determine visual element. In some embodiments, apparatus 100 may transmit visual element data structure to user device 140 and/or instructor device 124. In some embodiments, visual element data structure may configure user device 140 and/or instructor device 124 to display visual element. In some embodiments, visual element data structure may cause an event handler to be triggered in an application of user device 140 and/or instructor device 124 such as a web browser. In some embodiments, triggering of an event handler may cause a change in an application of user device 140 and/or instructor device 124 such as display of visual element.

Still referring to FIG. 1, in some embodiments, apparatus 100 may transmit visual element to a display. A display may communicate visual element to user and/or instructor. A display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, that allow user to input data into the display. Interactive elements may be configured to enable interaction between a user and a computing device. In some embodiments, a visual element data structure is determined as a function of data input by user into a display.

Still referring to FIG. 1, a variable and/or datum described herein may be represented as a data structure. In some embodiments, a data structure may include one or more functions and/or variables, as a class might in object-oriented programming. In some embodiments, a data structure may include data in the form of a Boolean, integer, float, string, date, and the like. In a non-limiting example, a user attribute score data structure may include an int value representing the value of the score. In some embodiments, data in a data structure may be organized in a linked list, tree, array, matrix, tenser, and the like. In a non-limiting example, a plurality of user attribute scores for a particular user may be organized in an array. In some embodiments, a data structure may include or be associated with one or more elements of metadata. A data structure may include one or more self-referencing data elements, which processor 104 may use in interpreting the data structure. In a non-limiting example, a data structure may include “<date>” and “</date>,” tags, indicating that the content between the tags is a date. In some embodiments, a data structure may be stored in, for example, memory 108 or a database.

Still referring to FIG. 1, in some embodiments, a data structure may be read and/or manipulated by processor 104. In a non-limiting example, a prompt data structure may be read and accepted or rejected by an instructor device 124.

Still referring to FIG. 1, in some embodiments, a data structure may be calibrated. In some embodiments, a data structure may be trained using a machine learning algorithm. In a non-limiting example, a data structure may include an array of data representing the biases of connections of a neural network. In this example, the neural network may be trained on a set of training data, and a back propagation algorithm may be used to modify the data in the array. Machine learning models and neural networks are described further herein.

Still referring to FIG. 1, in some embodiments, an instructor viewing user attribute scores 152 may be able to edit a user attribute score 152. For example, attribute generation machine learning model 156 output may lead to apparatus assigning a particular user a first user attribute score for a particular attribute, and an instructor listening in on that user's discussion may believe the correct value to be higher and may edit the user's score.

Still referring to FIG. 1, in some embodiments, apparatus 100 may display a transcript of a user discussion to an instructor. For example, apparatus 100 may store a transcript generated from discussion datum 148 by an automatic speech recognition system. Apparatus 100 may then determine user attribute score 152 based on discussion datum and display user attribute score 152 to instructor. In some embodiments, apparatus 100 may display a transcript of the relevant user discussion alongside user attribute score 152. In some embodiments, apparatus 100 may identify sections of a transcript of particular importance to user attribute score 152. Apparatus 100 may do this by, for example, analyzing user attribute score 152 as normal, and also without each response by the user in question. In this way, alternate user attribute scores may be determined as though the relevant user had not given a particular response. In some embodiments, apparatus 100 may identify one or more responses within discussion datum 148 that impacted the relevant user's user attribute score. For example, if a user spoke 5 times during a discussion, and 1 of them showed that he was very well prepared, but the other 4 were not particularly insightful, then when apparatus 100 re-analyzes his preparedness attribute without each response, apparatus 100 may determine that his score would have been much lower without that response; apparatus 100 may then highlight that response as important to the score when an instructor views the user's user attribute score 152.

Still referring to FIG. 1, in some embodiments, apparatus 100 may alter variables based on instructor input. For example, an instructor may be able to view and/or edit discussion topics 116, proposed prompts 132, user attribute scores 152, discussion datum 148 audio and/or transcripts, and the like. In some embodiments, an instructor may be able to make suggestions for future discussion sections. For example, an instructor may be able to speak a suggestion to alter a proposed prompt 132 aloud, and this may be recorded using a microphone, transcribed using an automatic speech recognition system, interpreted using a language model, and apparatus 100 may respond to the request by modifying the proposed prompt 132, such as by replacing it with an instructor suggestion.

With continued reference to FIG. 1, In some embodiments, instructor ratings of discussions and/or group generation may be used to train group generation machine learning model. processor 104 may use user feedback to train the machine-learning models and/or classifiers described above. For example, group generation machine learning model may be trained using past inputs and outputs of group generation machine learning model. In some embodiments, if user feedback indicates that an output of group generation machine learning model was “bad,” then that output and the corresponding input may be removed from training data used to train group generation machine learning model, and/or may be replaced with a value entered by, e.g., another user that represents an ideal output given the input the group generation machine learning model originally received, permitting use in retraining, and adding to training data; in either case, group generation machine learning model may be retrained with modified training data as described in further detail below. In some embodiments, training data of group generation machine learning model may include user feedback.

With continued reference to FIG. 1, in some embodiments, an accuracy score may be calculated for group generation machine learning model using user feedback, such as feedback from a student or professor. For the purposes of this disclosure, “accuracy score,” is a numerical value concerning the accuracy of a machine-learning model. For example, a plurality of user feedback scores may be averaged to determine an accuracy score. For example, user feedback for users belonging to a particular cohort of persons may be averaged together to determine the cohort accuracy score for that particular cohort of persons, and used as described above. For example, one cohort may include students, while another cohort may include instructors. Accuracy score or another score as described above may indicate a degree of retraining needed for a machine-learning model such as group generation machine learning model; processor 104 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

Still referring to FIG. 1, in some embodiments, apparatus 100 may assign study materials ahead of a discussion session. For example, apparatus 100 may determine discussion topic 116 as described above and may refer to a database including grade appropriate readings associated with discussion topic 116. In some embodiments, apparatus 100 may communicate such study materials to a user and/or instructor, such as by transmitting signals to user device 140 and/or instructor device 124.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, a training dataset may include example discussion data and example prompts, associated with example user attribute scores.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to particular grades (such as high school freshman, sophomore, junior, or senior), or particular subject matter (such as history, English, biology, math, or a particular sub-category of those subjects).

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include discussion datum 148 and prompt 132 as described above as inputs, user attribute score 152 as an output, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 2, apparatus 100 may use user and/or instructor feedback to train the machine-learning models and/or classifiers described above. For example, classifier may be trained using past inputs and outputs of classifier. In some embodiments, if user and/or instructor feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 2, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user and/or instructor feedback for users and/or instructors belonging to a particular cohort of persons may be averaged together to determine the cohort accuracy score for that particular cohort of persons and used as described above. Accuracy score or another score as described above may indicate a degree of retraining needed for a machine-learning model such as a classifier; apparatus 100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate that additional training data is needed.

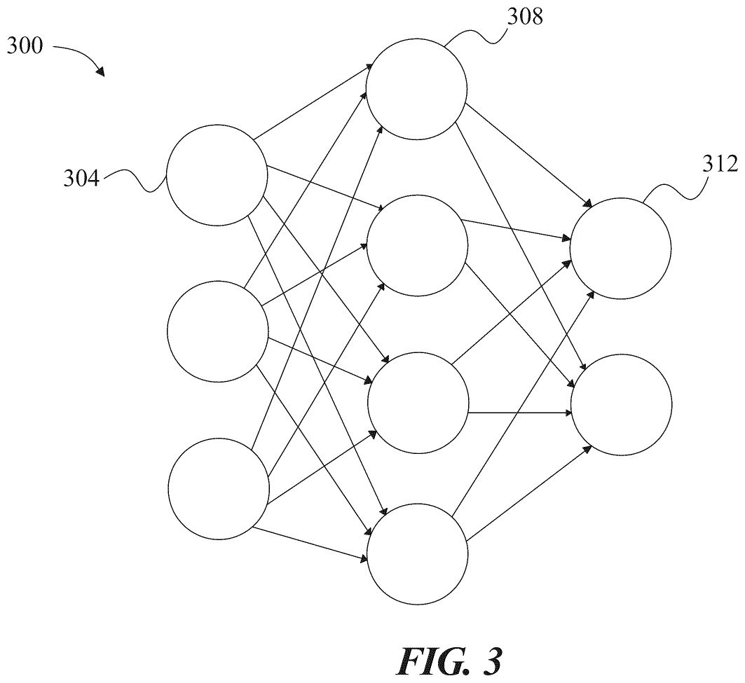

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

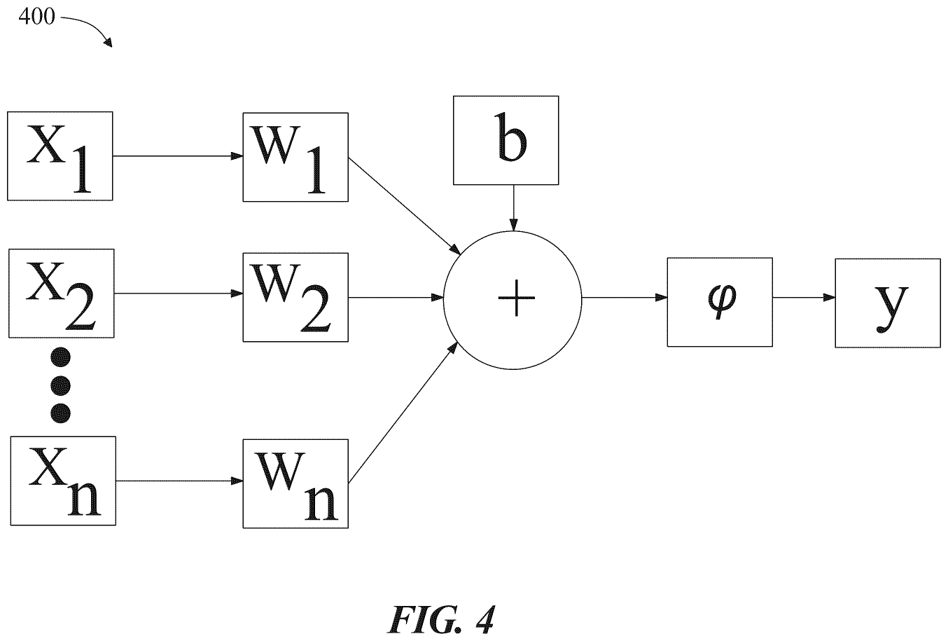

Referring now to FIG. 4, an exemplary embodiment of a node 400 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max (0, x), a “leaky” and/or “parametric” rectified linear unit function such as f(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 4, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

Still referring to FIG. 4, in some embodiments, a convolutional neural network may learn from images. In non-limiting examples, a convolutional neural network may perform tasks such as classifying images, detecting objects depicted in an image, segmenting an image, and/or processing an image. In some embodiments, a convolutional neural network may operate such that each node in an input layer is only connected to a region of nodes in a hidden layer. In some embodiments, the regions in aggregate may create a feature map from an input layer to the hidden layer. In some embodiments, a convolutional neural network may include a layer in which the weights and biases for all nodes are the same. In some embodiments, this may allow a convolutional neural network to detect a feature, such as an edge, across different locations in an image.

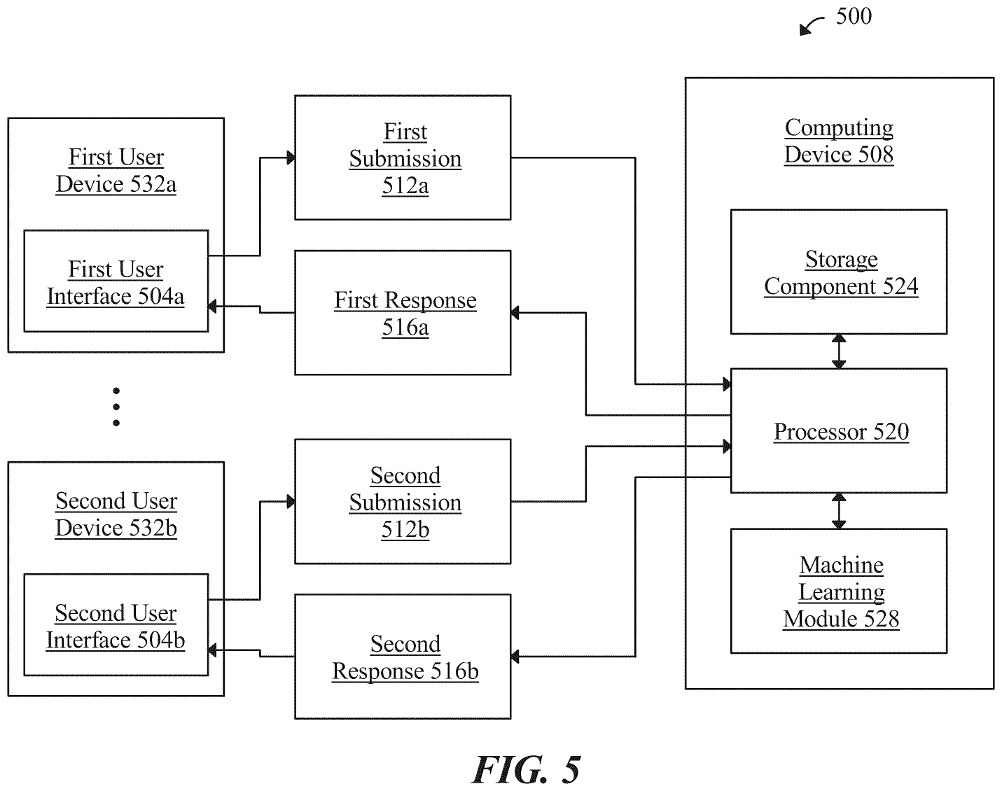

Now referring to FIG. 5, in some embodiments, apparatus 100 may communicate with user and/or instructor using a chatbot. According to some embodiments, one or more user interfaces including first user interface 504a and second user interface 504b on one or more user devices including first user device 532a and second user device 532b may be communicative with a computing device 508 that is configured to operate a chatbot. In some embodiments, one or more user devices may be communicative in this way, such as 1, 2, 3, 4, 5, 6, 7, 8, 9, 10, 20, 30, 40, 50, 60, 70, 80, 90, 100, or more user devices. In some embodiments, first user interface 504a may be local to first user device 532a. In some embodiments, additional user interfaces such as second user interface 504b may be local to their respective user devices. In some embodiments, first user interface 504a may be local to computing device 508. In some embodiments, additional user interfaces such as second user interface 504b may be local to computing device 508. Alternatively or additionally, in some cases, first user interface 504a may remote to first user device 532a and communicative with first user device 532a, by way of one or more networks, such as without limitation the internet. Alternatively or additionally, one or more user interfaces may communicate with computing device 508 using telephonic devices and networks, such as without limitation fax machines, short message service (SMS), or multimedia message service (MMS). Commonly, user interfaces such as first user interface 504a communicate with computing device 508 using text-based communication, for example without limitation using a character encoding protocol, such as American Standard for Information Interchange (ASCII). Typically, user interfaces conversationally interface with a chatbot, by way of at least a submission, from a user interface to the chatbot, and a response, from the chatbot to the user interface. For example, first user interface 504a may interface with a chatbot using first submission 512a and first response 516a. In another example, second user interface 504b may interface with a chatbot using second submission 512b and second response 516b. In some embodiments, submissions such as first submission 512a and/or responses such as first response 516a may use text-based communication. In some embodiments, submissions such as first submission 512a and/or responses such as first response 516a may use audio communication.

Still referring to FIG. 5, a submission such as first submission 512a once received by computing device 508 operating a chatbot, may be processed by a processor 520. In some embodiments, processor 520 processes a submission such as first submission 512a using one or more of keyword recognition, pattern matching, and natural language processing. In some embodiments, processor employs real-time learning with evolutionary algorithms. In some cases, processor 520 may retrieve a pre-prepared response from at least a storage component 524, based upon submission such as first submission 512a. Alternatively or additionally, in some embodiments, processor 520 communicates a response such as first response 516a without first receiving a submission, thereby initiating conversation. In some cases, processor 520 communicates an inquiry to a user interface such as first user interface 504a; and processor 520 is configured to process an answer to the inquiry in a following submission from the user interface. In some cases, an answer to an inquiry present within a submission from a user device may be used by computing device 508 as an input to another function. In some embodiments, computing device 508 may include machine learning module 528. Machine learning module 528 may include any machine learning models described herein. In some embodiments, a submission such as first submission 512a may be input into a trained machine learning model within machine learning module 528. In some embodiments, a submission such as first submission 512a may undergo one or more processing steps before being input into a machine learning model. In some embodiments, a submission such as first submission 512a may be used to train a machine learning model within machine learning module 528.

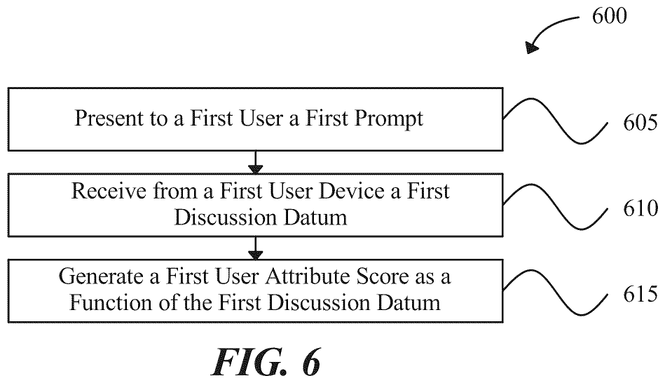

Referring now to FIG. 6, an exemplary embodiment of a method 600 of generating a user attribute score is illustrated. One or more steps of method 600 may be implemented, without limitation, as described above in reference to FIGS. 1-5. One or more steps of method 600 may be implemented, without limitation, using at least a processor.

Still referring to FIG. 6, in some embodiments, method 600 may include presenting to a first user a first prompt by transmitting to a first user device a signal, wherein the signal configures the first user device to display the first prompt 605. In some embodiments, presenting to the user the first prompt is done using a chatbot.

Still referring to FIG. 6, in some embodiments, method 600 may include receiving from the first user device a first discussion datum, wherein the first discussion datum may include a response by the first user to the first prompt 610.

Still referring to FIG. 6, in some embodiments, method 600 may include generating a first user attribute score as a function of the first discussion datum 615. In some embodiments, include generating a first user attribute score may include training an attribute generation machine learning model on a training dataset including example discussion data associated with example user attribute scores; inputting the first discussion datum into the attribute generation machine learning model; and receiving as an output from the attribute generation machine learning model the first user attribute score. In some embodiments, generating a first user attribute score may include transcribing the first discussion datum using an automatic speech recognition system.

Still referring to FIG. 6, in some embodiments, method 600 may include receiving a discussion topic.

Still referring to FIG. 6, in some embodiments, method 600 may include generating a first prompt as a function of the discussion topic. In some embodiments, generating a first prompt may include training a prompt generation machine learning model on a training dataset including example discussion topics associated with example prompts; inputting the discussion topic into the prompt generation machine learning model; and receiving as an output from the prompt generation machine learning model the first prompt.

Still referring to FIG. 6, in some embodiments, method 600 may include determining a user group as a function of the first user attribute score. In some embodiments, determining a user group includes training a group generation machine learning model using reinforcement learning; inputting the first user attribute score into the group generation machine learning model; and receiving as an output from the group generation machine learning model the user group.

Still referring to FIG. 6, in some embodiments, method 600 may include presenting to a second user a first prompt by transmitting to a second user device a signal, wherein the signal configures the second user device to display the first prompt; receiving from the second user device a second discussion datum, wherein the second discussion datum may include a response by the second user to the first prompt; generating a second user attribute score as a function of the second discussion datum by training an attribute generation machine learning model on a training dataset including example discussion data associated with example user attribute scores; inputting the second discussion datum into the attribute generation machine learning model; and receiving as an output from the attribute generation machine learning model the second user attribute score; and determining a user group as a function of the first user attribute score and the second user attribute score.

Still referring to FIG. 6, in some embodiments, method 600 may include generating a certainty score as a function of the first discussion datum. In some embodiments, method 600 may include generating a second prompt as a function of the discussion topic and the certainty score; and presenting to the user the second prompt; wherein the first discussion datum further may include a user response to the second prompt. In some embodiments, method 600 may include communicating the user attribute score to an instructor.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for generating a user attribute score, the apparatus comprising:
at least a processor; and
a memory communicatively connected to the at least processor, the memory containing instructions configuring the at least processor to:
receive a discussion topic, and
generate a first prompt as a function of the discussion topic by:
training a prompt generation machine learning model on a training dataset, wherein the training dataset correlates example discussion topics with example prompts;
inputting the discussion topic into the prompt generation machine learning model;
receiving, as an output, from the prompt generation machine learning model, the first prompt;
receiving feedback in a form of a cost function, wherein the feedback is used to train the prompt generation machine learning model;
wherein the prompt generation machine learning model is configured to output prompts similar to the first prompt as a function of low-cost function values; and
wherein the prompt generation machine learning model is configured to output prompts dissimilar to the first prompt as a function of high-cost function values;
present to a first user a first prompt by transmitting to a first user device a first signal, wherein the first signal configures the first user device to display the first prompt;
receive from the first user device a first discussion datum, wherein the first discussion datum comprises a response by the first user to the first prompt; and
generate a first user attribute score as a function of the first discussion datum by:
training an attribute generation machine learning model on a training dataset including example discussion data associated with example user attribute scores;
inputting the first discussion datum into the attribute generation machine learning model; and
receiving, as an output, from the attribute generation machine learning model, the first user attribute score; and
determine a user group as a function of the first user attribute score, wherein determining the user group comprises:
receiving training data of the first user attribute score as an input and the user group as an output;
training a group generation machine learning model using the training data;
updating the training data by removing past inputs and outputs from the group generation machine learning model as a function of user feedback; and
retrain the group generation machine learning model using the updated training data.

2. (canceled)

3. The apparatus of claim 1, wherein generating the first user attribute score comprises transcribing the first discussion datum into machine-readable text, using an automatic speech recognition system.

4. (canceled)

5. (canceled)

6. The apparatus of claim 1, wherein the memory contains instructions configuring the at least processor to:
present to a second user the first prompt by transmitting to a second user device a second signal, wherein the second signal configures the second user device to display the first prompt;
receive from the second user device a second discussion datum, wherein the second discussion datum comprises a response by the second user to the first prompt;
generate a second user attribute score as a function of the second discussion datum by: inputting the second discussion datum into the attribute generation machine learning model; and
receiving as an output from the attribute generation machine learning model the second user attribute score; and
determine a user group as a function of the first user attribute score and the second user attribute score.

7. The apparatus of claim 1, wherein the memory contains instructions configuring the at least processor to generate a certainty score as a function of the first discussion datum.

8. The apparatus of claim 7, wherein the memory contains instructions configuring the at least processor to:
generate a second prompt as a function of the discussion topic and the certainty score; and
present to the user the second prompt, wherein the first discussion datum further comprises a user response to the second prompt.

9. The apparatus of claim 1, wherein the memory contains instructions configuring the at least processor to communicate the user attribute score to an instructor.

10. The apparatus of claim 1, wherein presenting to the user the first prompt comprises presenting to the user the first prompt using a chatbot.

11. A method of generating a user attribute score, the method comprising:
receiving a discussion topic; and
generating a first prompt as a function of the discussion topic by:
training a prompt generation machine learning model on a training dataset, wherein the training dataset correlates example discussion topics with example prompts;
inputting the discussion topic into the prompt generation machine learning model;
receiving, as an output, from the prompt generation machine learning model, the first prompt;
receiving feedback in a form of a cost function, wherein the feedback is used to train the prompt generation machine learning model;
wherein the prompt generation machine learning model is configured to output prompts similar to the first prompt as a function of low-cost function values; and
wherein the prompt generation machine learning model is configured to output prompts dissimilar to the first prompt as a function of high-cost function values;
presenting to a first user a first prompt by transmitting to a first user device a first signal, wherein the first signal configures the first user device to display the first prompt;
receiving from the first user device a first discussion datum, wherein the first discussion datum comprises a response by the first user to the first prompt; and
generating a first user attribute score as a function of the first discussion datum by:
training an attribute generation machine learning model on a training dataset including example discussion data associated with example user attribute scores;
inputting the first discussion datum into the attribute generation machine learning model; and
receiving, as an output, from the attribute generation machine learning model, the first user attribute score;
determining a user group as a function of the first user attribute score, wherein determining the user group comprises:
receiving training data of the first user attribute score as an input and the user group as an output;
training a group generation machine learning model using the training data;
updating the training data by removing past inputs and outputs from the group generation machine learning model as a function of user feedback; and
retrain the group generation machine learning model using the updated training data.

12. (canceled)

13. The method of claim 11, wherein generating the first user attribute score comprises transcribing the first discussion datum into machine-readable text, using an automatic speech recognition system.

14. (canceled)

15. (canceled)

16. The method of claim 11, further comprising:
using at least a processor, presenting to a second user the first prompt by transmitting to a second user device a second signal, wherein the second signal configures the second user device to display the first prompt;
using at least a processor, receiving from the second user device a second discussion datum, wherein the second discussion datum comprises a response by the second user to the first prompt;
using at least a processor, generating a second user attribute score as a function of the second discussion datum by:
training an attribute generation machine learning model on a training dataset including example discussion data associated with example user attribute scores;
inputting the second discussion datum into the attribute generation machine learning model; and
receiving as an output from the attribute generation machine learning model the second user attribute score; and
using at least a processor, determining a user group as a function of the first user attribute score and the second user attribute score.

17. The method of claim 11, further comprising, using at least a processor, generating a certainty score as a function of the first discussion datum.

18. The method of claim 17, further comprising:
using at least a processor, generating a second prompt as a function of the discussion topic and the certainty score; and
using at least a processor, presenting to the user the second prompt;
wherein the first discussion datum further comprises a user response to the second prompt.

19. The method of claim 11, further comprising, using at least a processor, communicating the user attribute score to an instructor.

20. The method of claim 11, wherein presenting to the user the first prompt comprises presenting to the user the first prompt using a chatbot.
